(19) United States
(12) Patent Application Publication
(10) Pub. No.: US 2017/0124591 A1
(43) Pub. Date: May 4, 2017

(54) IDENTIFYING CONTEXTUAL KEYWORDS BASED ON REMARKETING LISTS

(71) Applicants: Eu-Jin Goh, Palo Alto, CA (US); Manojav Patil, Sunnyvale, CA (US)

(72) Inventors: Eu-Jin Goh, Palo Alto, CA (US); Manojav Patil, Sunnyvale, CA (US)

(73) Assignee: GOOGLE INC., Mountain View, CA (US)

(21) Appl. No.: 13/552,791

(22) Filed: Jul. 19, 2012

(51) Int. Cl. G06Q 30/02

(52) U.S. Cl. CPC G06Q 30/0256

(57) ABSTRACT

Methods, and systems, including computer programs encoded on computer-readable storage mediums, including a method for identifying keywords for a contextual advertisement campaign based on a remarketing list. The method including accessing a remarketing list identifying user identifiers; accessing user identifier history data specifying user events caused by users of the user devices; identifying keywords that caused the advertisements to be presented to the users; for each of the keywords: determining whether a first performance measure of advertisements that the keyword caused to be presented meets a first performance threshold; in response to determining that the first performance measure of advertisements that the keyword caused to be presented meets the first performance threshold, identifying the keyword as a target keyword; generating keyword suggestions from the target keywords; and providing the keyword suggestions to the advertiser.

### BACKGROUND

This specification generally relates to Internet advertising.

The Internet provides access to a wide variety of resources. For example, video and/or audio files, web pages for particular subjects or particular news articles and other content are accessible over the Internet. Access to these resources presents opportunities for advertisements to be provided with the resources.

Advertisers can target particular audiences to which their advertisements are shown based on keywords or topics associated with the content of the resources. For example, advertisers can select keywords relevant to the content of resources that their target audiences are likely to access such that when users access such resources the advertisers' advertisements are eligible to be provided to the users along with the resources. However, effectively identifying keywords that are relevant or related to the content of resources which are of interest to a target audience (and increase the performance of the advertisers' advertisements) is not a trivial task.

### SUMMARY

In general, one aspect of the subject matter described in this specification can be implemented in methods that include accessing remarketing data specifying a remarketing list for an advertiser identifying user identifiers associated with user devices that have performed an action that caused the user identifier to be included in the remarketing list; accessing user identifier history data specifying user events caused by users of the user devices, wherein the user events comprise selections of advertisements presented to the users by the user devices; identifying keyword data specifying keywords that caused the advertisements to be presented to the users; for each of the keywords: determining whether a first performance measure of advertisements that the keyword caused to be presented meets a first performance threshold; in response to determining that the first performance measure of advertisements that the keyword caused to be presented meets the first performance threshold, identifying the keyword as a target keyword; generating keyword suggestions from the target keywords, the keyword suggestions specifying keywords for use in targeting advertisements of the advertiser to users that include users that are not identified by user identifiers on the remarketing list; and providing the keyword suggestions to the advertiser.

Other embodiments of this aspect include corresponding systems, apparatus, and computer programs, configured to perform the actions of the methods, encoded on computer storage devices.

These and other embodiments can each optionally include one or more of the following features. The first performance measure can be a number of impressions. The first performance measure can be a number of advertisement selections. The method can include generating campaign data specifying an advertising campaign for the advertiser based at least in part on one or more of the keyword suggestions. The method can include receiving campaign selection data indicating that the advertiser has activated the advertising campaign.

The user events can include impressions of the advertisements to the users by the user devices. The action that caused the user identifier to be included in the remarketing list can include requesting a web page of the advertiser. The user events can include selections of advertisements presented to a user by the user device during a time period before a time the user device requested the web page of the advertiser and during a time period after the user device requested the web page of the advertiser.

Generating keyword suggestions can include, for each of the target keywords, determining a positional order of the target keyword with respect to other target keywords based on a second performance measure of advertisements that the target keyword caused to be presented and generating the keyword suggestions based on the positional orders.

The second performance measure can be an advertisement click through rate. The method can include receiving, from the advertiser, selections of one or more of the keyword suggestions, each selection specifying a keyword suggestion for targeting advertisements of the advertiser to users that are not identified by user identifiers on the remarketing list.

Particular implementations of the subject matter described in this specification can be implemented to realize one or more of the following advantages. Keywords for use in a contextual advertising campaign for an advertiser are selected based on the actions of users (e.g., as identified by anonymized user data) on a remarketing list for the advertiser. For example, keywords that triggered advertisements, which users from the advertiser's remarketing list have selected and/or from which a conversion occurred, are identified as keywords for the advertiser's contextual advertising campaign that targets advertisements to users that are not on the advertiser's remarketing list.

As such keywords have resulted in advertisements being selected and/or converted by users relevant to or targeted by the advertiser (given that the users are from the advertiser's remarketing list) they are likely good keywords for use in other areas besides the remarketing list, such as the advertiser's advertising campaign that is not limited to remarketing lists. Using keywords that have historically been effective at reaching the advertiser's target audience (e.g., users on the remarketing list) can increase the performance of the advertiser's advertising campaign (e.g., increase the conversion rate to increase advertiser's return on advertising investment). Further, such keywords can also be used to reach new users of the advertiser's target audience. For example, such users are users not included on the remarketing list but have similar interests or other commonalities to the users on the remarketing list such as an interest in subject matter related to the identified keywords, which as described below, may result in the advertiser's advertisements being presented to such new users.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a keyword identification system can be implemented.

FIG. 2 is a flow diagram of an example process for providing keyword suggestions to an advertiser.

FIG. 3 is a flow diagram of an example process for determining positional orders of keyword suggestions.

FIG. 4 is a block diagram of a programmable processing system.

Like reference numbers and designations in the various figures indicate like elements.

### DETAILED DESCRIPTION

This description generally relates to using a remarketing list to identify keywords that an advertiser can employ for use in a contextual advertisement campaign. A remarketing list is a list of users (e.g., as identified by anonymized user data) that have previously visited the advertiser's website or have otherwise expressed an interest in the advertiser's products or services.

More particularly, advertisements selected (e.g., clicked-on) by users on the remarketing list are identified from the users' history data. The keywords that caused or triggered these advertisements to be presented to the users are then identified. Keyword suggestions are generated from these identified keywords and provided to the advertiser for use in targeting the advertiser's advertisements. In some implementations, the keyword suggestions/target keywords are ranked based on various performance metrics such as click-through-rate. The highest ranked keywords can be presented to the advertiser as keyword suggestions to use in the advertiser's advertisement campaign.

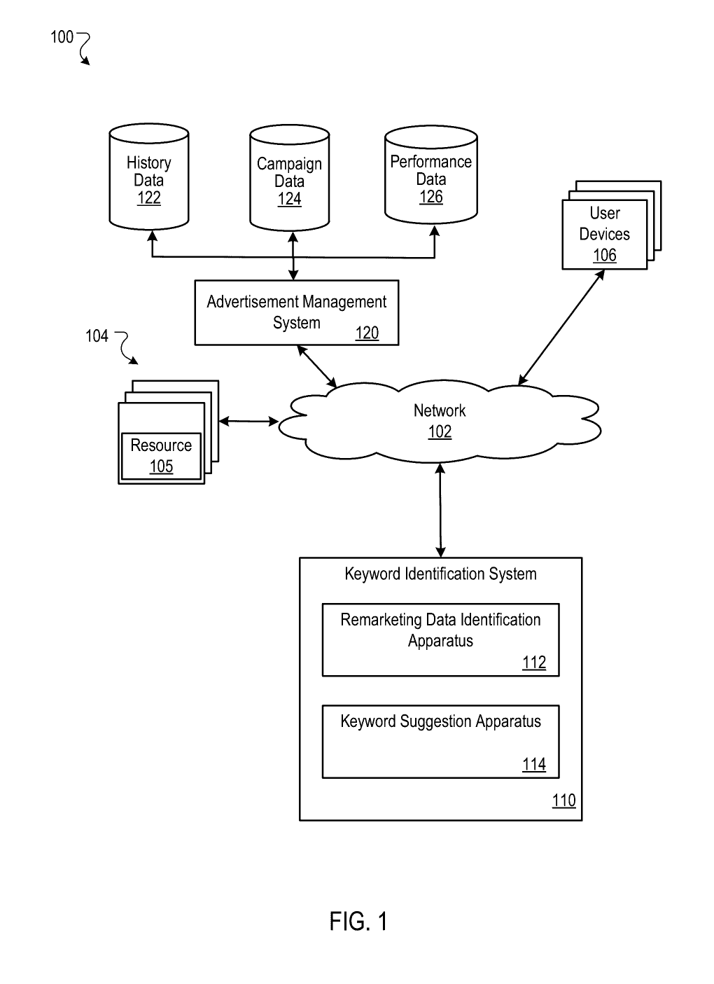

FIG. 1 is a block diagram of an example environment 100 in which a keyword identification system 110 can be implemented. A network 102, such as a local area network (LAN), wide area network (WAN), the Internet, or a combination thereof, connects websites 104, user devices 106, a keyword identification system 110 and an advertisement management system 120. The environment 100 may include many thousands of websites 104 and user devices 106.

A website 104 includes one or more resources 105 associated with a domain name and hosted by one or more servers. An example website 104 is a collection of web pages formatted in hypertext markup language (HTML) that can contain text, images, multimedia content, and programming elements, such as scripts. Each website 104 is maintained by a content publisher, which is an entity that controls, manages and/or owns the website 104.

A resource 105 is any data that can be provided by or accessed from a website 104 over the network 102 and that is associated with a resource address. Resources 105 include HTML pages, word processing documents, and portable document format (PDF) documents, images, video, and feed sources, to name just a few. The resources 105 can include content, such as words, phrases, pictures, and so on, and may include embedded information (such as meta information and hyperlinks) and/or embedded instructions (such as JavaScript scripts).

A user device 106 is an electronic device that is under the control of a user and is capable of requesting and receiving resources 105 over the network 102. Example user devices 106 include personal computers, mobile communication devices, and other devices that can send and receive data over the network 102. A user device 106 typically includes a user application, such as a web browser, to facilitate the sending and receiving of data over the network 102. The web browser can enable a user to display and interact with text, images, videos, music and other information typically located on a web page at a website 104 on the world wide web or a local area network.

The advertisement management system 120 facilitates the provisioning of advertisements with the resources 105. In particular, the advertisement management system 120 allows advertisers to define targeting rules that take into account attributes of the particular user to provide targeted advertisements to the users. Example targeting rules include keyword targeting, in which advertisers provide bids for keywords that are present in either search queries or webpage content. Advertisements that are associated with keywords having bids that result in an advertisement slot being awarded to the advertisement in an auction are selected for display in the advertisement slots with the relevant resource 105 (e.g., a search results page).

When a user of a user device 106 selects an advertisement, the user device 106 generates a request for a landing page of the advertisement, which is typically a webpage of the advertiser. This, in turn, results in the landing page being presented by the user device 106 to the user.

Targeted advertisements can be provided for many different resources 105, such as general content resources 105 (e.g., news web pages) and search results page resources 105. For example, a resource 105 includes instructions that cause the user device 106 to request advertisements from the advertisement management system 120. The request includes a website identifier and, optionally, keyword identifiers related to the content of the resource 105. The advertisement management system 120, in turn, provides targeted advertisements to the particular user device 106 based, for example, on the content of the resource 105 on which the advertisement will be presented.

The advertisement management system 120 includes a history data store 122, a campaign data store 124 and a performance data store 126. The history data store 122 stores data specifying user events caused by users of user devices 106. For example, the user events include selections of advertisements (e.g., click throughs), advertisement conversions, web page views and the like. The data specifying the user events can be anonymized so that the privacy of the users is protected. For example, quasi-unique identifiers can be associated with users and/or user events, but the actual identifying information is not stored in the history data store 122. Further, encryption and obfuscation techniques can also be used to protect the privacy of users. Moreover, in some implementations, users are provided the opportunity to opt/in or out of such information collection.

The campaign data store 124 stores data specifying advertisements, targeting information for the advertisements such as keywords, and budgeting information for advertising campaigns. The campaign data store 124 also stores data specifying remarketing lists for the advertisers. A remarketing list for an advertiser is a list of user identifiers associated with user devices 106 that have performed a particular action or one of a group of particular actions associated with the advertiser's advertisement(s) or resource(s) 105. For example, a remarketing list for an advertiser is a list that identifies user identifiers of users that have visited the advertiser's web page (e.g., caused a user device 106 to request the advertiser's web page) or have caused a selection of the advertiser's advertisement. As described above, the user identifiers can be subjected to one or more processes to protect the privacy of users.

The performance data store 126 stores data specifying the performance of advertisements and specifying the keywords that caused the advertisements to be presented (e.g., the keywords that triggered the advertisements). Such performance data can include, for example, click through and conversion rates for advertisements, the number of impressions and conversions for advertisements and, for each impression of an advertisement, the keyword that triggered or caused the impression. An impression occurs when an advertisement is displayed by a user device 106 (e.g., displayed on a search results page resource 105). A conversion occurs when a user performs a particular action related to an advertisement such as clicking on the advertisement and purchasing a good or service or signing up for a distribution list.

The campaign data store 124 and the performance data store 126 can be used as input parameters to an advertisement auction. As described above, the advertisement management system 120, in response to each request for advertisements, conducts an auction to select advertisements that are provided in response to the request. In some implementations, the advertisements are ranked according to a score that is proportional to a value based on advertisement bids specified in the campaign data store 124 and one or more parameters specified in the performance data 124 (e.g., click through rate). The highest ranked advertisements resulting from the auction are selected and provided to the requesting user device 106.

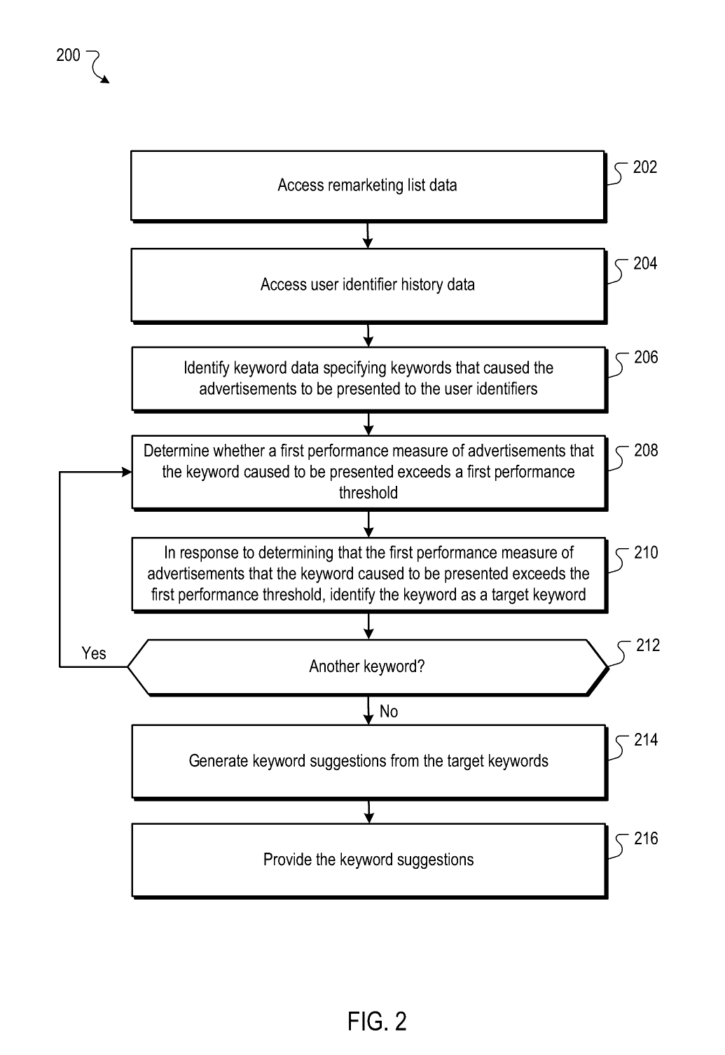

Advertisers may attempt to increase the performance of their advertisements (e.g., click through rates or conversion rates) or target a particular user audience by changing or adjusting campaign parameters. For example, an advertiser may specify different and/or additional keywords that can be used to target the advertiser's advertisements. However, selecting keywords to increase advertisement performance or target a particular user audience can be challenging. As described below, the keyword identification system 110 can provide keyword suggestions to the advertiser to aid the advertiser in meeting the advertiser's performance or targeting goals. In some implementations, the keyword identification system 110 includes a remarketing data identification apparatus 112 and a keyword suggestion apparatus 114. The operation of keyword identification system 110 is described below with reference to FIG. 2, which is flow diagram of an example process for providing keyword suggestions to an advertiser.

The process 200 accesses remarketing data (202). The remarketing data specify a remarketing list for an advertiser. The remarketing list identifies user identifiers associated with user devices 106 that have performed an action that caused the user identifier to be included in the remarketing list. For convenience, a user identifier and a user that caused the user device 106 associated with the user identifier to perform the action will be used interchangeably herein as appropriate. In some implementations, the remarketing data identification apparatus 112 accesses or otherwise obtains the remarketing data. For example, the remarketing data identification apparatus 112 accesses the remarketing data from a remarketing list data store (not shown) that stores remarketing lists indexed by advertiser or advertising campaign.

As described above, a remarketing list for an advertiser is a list of users that, for example, through the use of respective user devices 106, have accessed the advertiser's website 104, have purchased a product or service from the advertiser, or have otherwise expressed an interest in the advertiser's products or services or performed some action (e.g., completed an online survey or form), to be included on a remarketing list. For example, a first remarketing list identifies all users that have visited a particular advertiser's web page, web page T, advertising electronic repair services between March 1 and March 31. For convenience, as used herein, a user visiting or accessing a web page is the same as a user causing a user device 106 to visit or access the web page. The first remarketing list identifies user identifiers A, B, C, D and E as having visited the web page T between March 1 and March 31. In some scenarios, there may be many thousands or tens of thousands of user identifiers on a remarketing list.

In some implementations, similar to that described above for user events, the user identifiers are anonymized so that the privacy of the users associated with the user identifiers is protected and, further, the users are provided the opportunity to opt/in or out of such information collection.

The process 200 accesses user identifier history data specifying user events caused by users of the user devices (204). The user events include, for example, selections of advertisements (e.g., click throughs), conversions and browsing activity of the users. In some implementations, the remarketing data identification apparatus 112 accesses the user identifier history data from the history data store 122. For example, the user events are stored and indexed according to the users/user identifiers causing the user events, and the remarketing data identification apparatus 112 accesses the user event data based on the user/user identifier.

In some implementations, the remarketing data identification apparatus 112 accesses data describing user events that occurred during a specified time period from the history data store 122 for the user identifiers identified on a remarketing list (e.g., from process 202). In some implementations, the specified time period is the same duration for each user identifier but, for each user identifier, centered around the date that the particular user identifier was added to the remarketing list. For example, the specified period of time for a user identifier is a four week period that includes the two weeks before and the two weeks after the user identifier was added to the remarketing list. However, in other implementations, the specified period of time is the same duration for each user identifier and centered around the same date for each user identifier.

As described above, the remarketing data identification apparatus 112 can access data describing user events such as click throughs from the history data store 122. For example, the remarketing data identification apparatus 112 accesses click-through data for the user identifiers identified on the first remarketing list, user identifiers A-E, which are included in Table 1 for the time period from March 1 to March 31:

TABLE 1

| User Identifier | Ad 1 | Ad 2 | Ad 3 | Ad 4 | Ad 5 | Ad 6 |
|---|---|---|---|---|---|---|
| User Identifier A | X | | X | | X | X |
| User Identifier B | | | X | | X | X |
| User Identifier C | X | X | X | X | | X |
| User Identifier D | X | | X | | X | X |
| User Identifier E | | X | X | | X | |

Table 1 includes six advertisements, Ad 1-Ad 6, which relate to, respectively, television cables, DVD players, audio speakers, wall mounts for televisions, LCD televisions, and plasma televisions. Table 1 specifies, for example, that user identifier A selected (e.g., clicked on) Ads 1, 3, 5 and 6 during the period from March 1 to March 31 and that user identifier E selected Ads 2, 3 and 5 during the same time period. In some scenarios, the relevant user events include many thousands or tens of thousands of click throughs for many different advertisements.

The process 200 identifies keyword data specifying keywords that caused the advertisements to be presented to the users (206). A keyword that caused an advertisement to be presented to a user is a keyword for the advertisement that caused the advertisement to be eligible and to be presented along with or in addition to the web resource 105 to which the keyword is relevant or related (“triggering keyword”). For example, an advertiser specifies the term “electronic repair” as the keyword for the advertiser's advertisement for television repair services. Thus in response to a user accessing a how-to web page titled “The Do It Yourself Guide To Electronic Repair,” the advertisement management system 120 determines that the advertiser's advertisement for television repair services is eligible to and is presented in an ad slot on the how-to web page (e.g., if the advertisement wins an auction for the ad slot) because the how-to web page includes the advertiser-specified keywords. In other words, “electronic repair” is the triggering keyword for the advertiser's advertisement to be presented as it is content relevant to the how-to web page.

By way of another example, in response to a user causing the search query “electronic repair manuals” to be submitted to an online search system, the advertisement management system 120 determines that the advertiser's advertisement for television repair services is eligible to be and is presented in an ad slot on the corresponding search results web page because the search query includes, and is thus content relevant to, the advertiser-specified keywords.

In some implementations, a triggering keyword is expanded to include synonyms of the triggering keyword, roots of the triggering keyword or other terms related to the triggering keyword. For example, in such implementations, if a submitted search query includes a synonym of the triggering keyword, the triggering keyword is still identified in the keyword data as the keyword that caused the advertisement to be presented. In some implementations, keywords relevant to the subject matter of web pages presented to user identifiers listed on a remarketing list (or keywords relevant to other user browsing history events stored in the user history data store 122) can also be used as triggering keywords. For example, keywords relevant to web pages that were presented for a minimum period of time (dwell time) during user browsing sessions associated with the user identifiers can be used as triggering keywords. In such cases, the keyword suggestion apparatus 114 receives data indicating the dwell times (e.g., by client side analytics scripts, for example). For dwell times that meet the minimum period of time, the keywords relevant to the subject matter of web pages are identified as triggering words.

In some implementations, the keyword suggestion apparatus 114 identifies (e.g., requests or parses) the keyword data from the performance data store 124, which, as described above, stores data specifying the triggering keywords. For example, the triggering keywords are stored and indexed according to the advertisements that they triggered.

In some implementations, the keyword suggestion apparatus 114 identifies the triggering keywords based on the advertisements that they triggered. For example, the keyword suggestion apparatus 114 uses the user events accessed by the remarketing data identification apparatus 112 from Table 1 to identify the triggering keywords from the performance data store 124, which are shown below in Table 2:

TABLE 2

| User Identifier | Ad 1/TK | Ad 2/TK | Ad 3/TK | Ad 4/TK | Ad 5/TK | Ad 6/TK |
|---|---|---|---|---|---|---|
| User Identifier A | cables | | speakers | | LCD | electronics |
| User Identifier B | | | cables | | television | cables |
| User Identifier C | HDMI | DVD | surround | wall | | plasma |
| | | | sound | mounts | | |
| User Identifier D | splitter | | speakers | | discount | televisions |
| | | | | | televisions | |
| User Identifier E | | cables | 5.1 | | television | |

Table 2 shows the triggering keywords (“TK”) that triggered the advertisements Ad 1-Ad 6. For example, “cables,” “HDMI” and “splitter” are the triggering keywords that triggered Ad 1 to be presented to user identifiers A, C and D, respectively. Likewise, “LCD,” “television,” “discount televisions” and “television” are the triggering keywords that triggered Ad 5 to be presented to user identifiers A, B, D and E, respectively. As such, the triggering keywords for any particular advertisement can be the same or different.

The process 200 determines whether a first performance measure of advertisements that the keyword caused to be presented meets a first performance threshold (208). In some implementations, the keyword suggestion apparatus 114 performs this determination. The first performance measure can be, for example, a number (or percentage) of impressions, click throughs, conversions or a combination thereof. The first performance threshold can be, for example, a minimum number (or percentage) of impressions, click throughs, conversions or a combination thereof.

Thus the performance measure is based on the performance of advertisements triggered by the particular triggering keyword of interest. For example, for a click through threshold of at least two click throughs (e.g., first performance threshold), the keyword suggestion apparatus 114 determines that the triggering keywords “cables,” “speakers” and “television” each triggered advertisements that in the aggregate accounted for at least two click throughs. In other words, in some implementations, the keyword suggestion apparatus 114 aggregates the click throughs for each advertisement triggered by the respective triggering keyword and determines the first performance measure to be the aggregated number of click throughs. Thus the advertisements triggered by each of these three triggering keywords have a first performance measure (e.g., from Tables 1 and 2) that meets the first performance threshold of two click throughs. For example, the triggering keyword “cables” triggered Ad 1 for user identifier A, Ad 2 for user identifier E, Ad 3 for user identifier B and Ad 6 for user identifier B.

In some implementations, the keyword suggestion apparatus 114 can use the first performance measure and threshold to eliminate or disregard triggering keywords without enough advertisement performance data to meet a desired confidence level (e.g., as determined through a statistical analysis of the advertisement performance data). For example, the keyword suggestion apparatus 114 de-designates a keyword as a triggering keyword if the first performance measure for advertisements triggered by the keyword do not meet the first performance threshold.

In some implementations (e.g., in which triggering keywords are determined from keywords relevant to web pages presented to user identifiers or otherwise relevant based on browsing histories associated with the user identifiers) the first performance measure can be, for example, dwell times on web pages relevant to particular triggering keywords, numbers of web pages presented that are relevant to particular triggering keywords or a combination thereof. In such implementations, the first performance threshold can be, for example, a minimum dwell time, a minimum number of web page presentations or a combination thereof.

The process 200, in response to determining that the first performance measure of advertisements that the keyword caused to be presented meets the first performance threshold, identifies the keyword as a target keyword (210). In some implementations the keyword suggestion apparatus 114 determines that the first performance measure of advertisements triggered by the triggering keyword meets the first performance threshold and, in response, identifies the triggering keyword as a target keyword. For example, the keyword suggestion apparatus 114 determines that Ad 1, Ad 2, Ad 3 and Ad 6, triggered by “cables,” meets the first performance threshold (e.g., at least two click throughs) and, in response, identifies “cables” as a target keyword. In a similar manner, the keyword suggestion apparatus 114 also identifies “speakers” and “television” as target keywords.

The process 200 repeats processes 208 -210 for each of the keywords identified in process 206 (212). In some implementations, the keyword suggestion apparatus 114 repeats processes 208-210 for each of the triggering keywords.

The process 200 generates keyword suggestions from the target keywords (214). The keyword suggestions specify keywords for use in, for example, targeting advertisements of the advertiser to users that include users that are not identified on the remarketing list. Thus, as described below, the keyword suggestions can be used to expand the target audience of the advertiser to include users that likely have some commonalities with users on the remarketing list (e.g., interest in content related to the target keywords).

In some implementations, the keyword suggestions are the target keywords. With respect to the above example, the keyword suggestions are “cables,” “speakers” and “television.” In some implementations, the keyword suggestions include the target keywords and keyword expansions of the target keywords. Keyword expansions are terms related to the target keywords and can include, for example, synonyms of the target keywords, roots of the target keywords or terms otherwise related to the target keywords.

The process 200 provides the keyword suggestions to the advertiser (216). In some implementations, the keyword suggestion apparatus 114 provides the keyword suggestions to the advertiser. For example, the keyword suggestion apparatus 114 provides the keyword suggestions to the advertiser to use in a contextual advertising campaign, which is an advertising campaign in which advertisements are selected for presented to a user based on the content displayed to the user (e.g., the content of the web page). Advertisers, however, may only prefer to use some proper subset of the keyword suggestions provided to them.

In some implementations, the keyword suggestion apparatus 114 receives from the advertiser a selection of one or more (e.g., but not all) of the keyword suggestions that the advertiser desires to use in the advertiser's advertising campaign. The keyword suggestion apparatus 114, in turn, provides the selected keyword suggestions to the advertisement management system 120 to use in the advertiser's advertising campaign. For example, as described below, the selected keyword suggestions can be used to target advertisements to users that are not identified on the remarketing list.

The keyword suggestions are likely good keywords for the advertiser because users from the remarketing list, known or suspected to be interested in the advertiser's goods or services, have selected advertisements (e.g., expressed an interest in the subject matter of the advertisements) triggered by the keyword suggestions. As such, it is likely that the keyword suggestions will trigger the advertiser's advertisements to be presented to users that have similar interests to those of users on the remarketing list (e.g., including users different from those on the remarketing list) as the keyword suggestions will be used in a contextual advertising campaign. For example, as the triggering keywords trigger advertisements based on the content of, for example, a resource 105 or a search query, users viewing or requesting content related to that of a triggering keyword, which is likely of interest to users in the advertiser's target audience, can be presented the advertiser's advertisement.

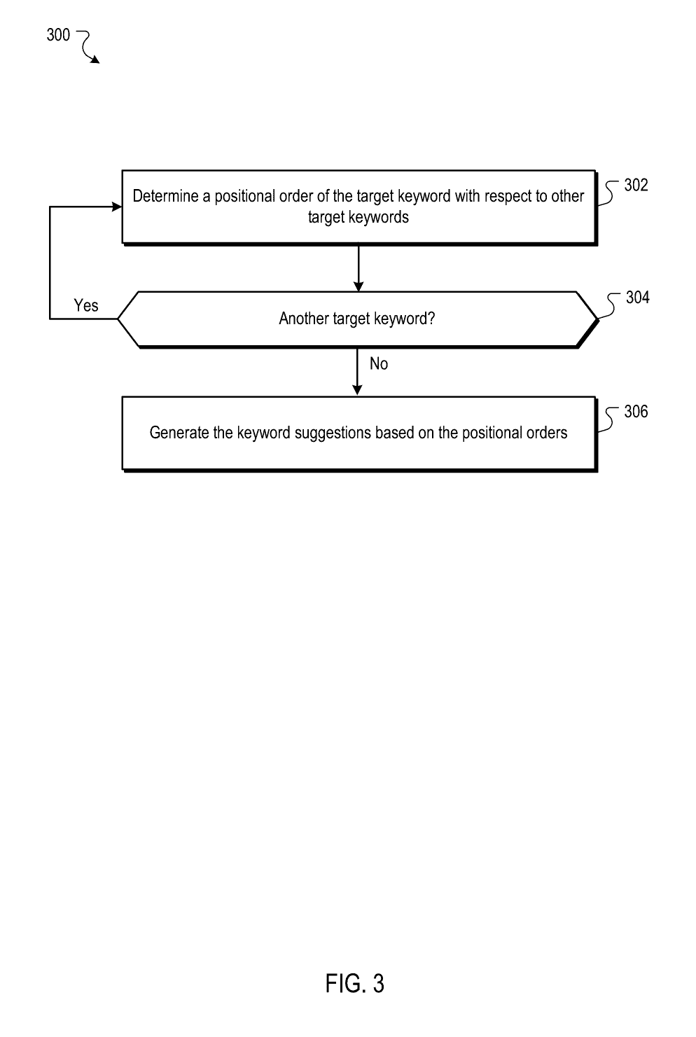

In some scenarios, given that there may be many thousands of triggering keywords that trigger advertisements that meet the first performance threshold, the keyword suggestion apparatus 114 can order or otherwise sort or limit the keyword suggestions before providing them to the advertiser. In some implementations, the keyword suggestion apparatus orders the keyword suggestions as described with reference to FIG. 3, which is a flow diagram of an example process for determining positional orders of keyword suggestions.

The process 300 determines a positional order of the target keyword with respect to other target keywords based on a second performance measure of advertisements that the target keyword caused to be presented (302). In some implementations, the second performance measure is an advertisement click through rate or conversion rate. For example, for advertisements triggered by a target keyword, the second performance measure for the advertisements is the ratio of the number of click throughs for the advertisements during a specified time period to the number of impressions for the advertisements during the same time period (e.g., click through rate). The keyword suggestion apparatus 114 can determine second performance measures for some or all of the target keywords. For example, the second performance measure is a click through rate and the second performance measures for “cables,” “speakers” and “television” are 0.12, 0.07 and 0.11, respectively.

The positional order of a target keyword is the position of the target keyword in an ordered set of target keywords. In some implementations, the keyword suggestion apparatus 114 determines the positional order for the target keywords based on second performance measures. For example, the keyword suggestion apparatus 114 determines the positional order of “cables,” “speakers” and “television” to be 1, 3 and 2, respectively. “Cables” has a first positional order as it has the highest (e.g., best) second performance measure (e.g., click through rate) and “speakers” has a third positional order as it has the lowest (e.g., worst) second performance measure.

The process 300 repeats process 302 for each of the target keywords (304). In some implementations, the keyword suggestion apparatus 114 repeats the process 302 for each target keyword.

The process 300 generates the keyword suggestions based on the positional orders (306). In some implementations, the keyword suggestion apparatus 114 generates the keyword suggestions based on the positional orders. Further, in some implementations, the keyword suggestion apparatus 114 only provides a specified number of the most highly ordered keyword targets to the advertiser as keyword suggestions (e.g., the keyword targets with the most favorable second performance measures). For example, the specified number can be a static number (e.g., 10) or it can be based a second performance measure threshold (e.g., all keyword targets with advertisements that have aggregate second performance measures above X threshold such as above a 0.1 click through rate). Regardless, the positional order indicates the relative performance for a keyword target (e.g., the second performance measure) with respect to those of other keyword targets.

Given that some advertisers have many advertising campaigns and the attendant challenges in managing such campaigns (e.g., analyzing the performances of such campaigns and selecting keywords for the campaigns), in some implementations, the keyword identification system 110 generates campaign data specifying an advertising campaign for the advertiser based at least in part on one or more of the keyword suggestions. In this way, the keyword identification system 110 automatically sets up an advertising campaign for the advertiser without the involvement of the advertiser thereby alleviating the burden on the advertiser of analyzing the relevant performance metrics and determining which keywords to use in the campaign. For example, the keyword identification system 110 can identify the products or services from which the remarketing list was generated (e.g., from the advertisement management system 120) and use the advertiser's advertisements for those products or services along with the keyword suggestions derived from the remarketing list (e.g., as described in process 200) to generate a turnkey advertising campaign for the advertiser.

In response to receiving campaign selection data from the advertiser indicating that the advertiser desires to activate the turnkey advertising campaign, the keyword identification system 110 can, for example, provide the advertising campaign to the advertisement management system 120 to run.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

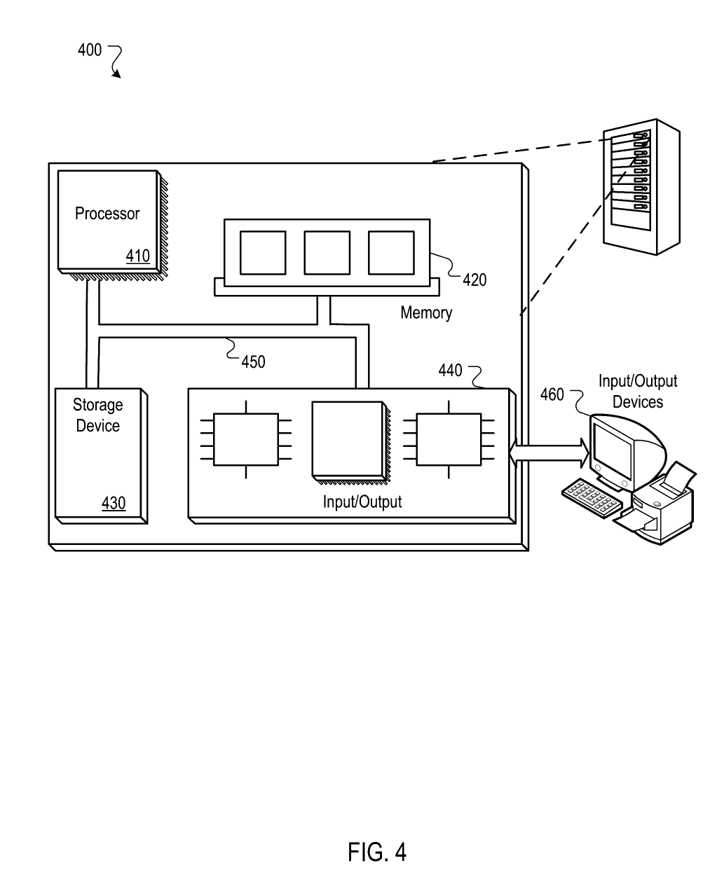

An example of one such type of computer is shown in FIG. 4, which shows a block diagram of a programmable processing system (system). The system 400 that can be utilized to implement the systems and methods described herein. The architecture of the system 400 can, for example, be used to implement a computer client, a computer server, or some other computer device.

The system 400 includes a processor 410, a memory 420, a storage device 430, and an input/output device 440. Each of the components 410, 420, 430, and 440 can, for example, be interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 300. In one implementation, the storage device 430 is a computer-readable medium. In various different implementations, the storage device 430 can, for example, include a hard disk device, an optical disk device, or some other large capacity storage device.

The input/output device 440 provides input/output operations for the system 400. In one implementation, the input/output device 440 can include one or more of a network interface device, e.g., an Ethernet card, a serial communication device, e.g., and RS-232 port, and/or a wireless interface device, e.g., an 802.11 card. In another implementation, the input/output device can include driver devices configured to receive input data and send output data to other input/output devices, e.g., keyboard, printer and display devices 460.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
accumulating multiple different user identifiers of multiple different users that each have previously visited a same advertiser's website;
generating a remarketing list that includes lists the user identifiers of the users that have visited the same advertiser's website;
accessing user identifier history data that specifies user events that were performed by the users in the remarketing list, wherein the user events comprise selections of advertisements presented to the users and web pages visited by the users;
identifying keyword data specifying first keywords that contributed to presentation of the advertisements to the users in the remarketing list;
for each of one or more of the first keywords:
determining, by one or more data processors, that a first performance measure of advertisements that were presented to users in the remarketing list based on the first keyword meets a first performance threshold; and
in response to determining that the first performance measure meets the first performance threshold, identifying the first keyword as a target keyword;
identifying, based on the user identifier history data, dwell times for the visits to the web pages by the users in the remarketing list, wherein the dwell time is based on a presentation period for the web pages;
identifying second keywords that describe subject matter of the web pages visited by the users in the remarketing list;
for each of one or more of the second keywords:
determining that the dwell time for the web pages described by the second keyword meets a minimum dwell time; and
in response to determining that the dwell time meets the minimum dwell time, identifying the second keyword as a target keyword;
generating keyword suggestions from the target keywords, the keyword suggestions specifying keywords for use in targeting advertisements of the advertiser to users not included in the remarketing list, wherein the keyword suggestions include at least one of the second keywords that was identified as a target keyword;
providing the keyword suggestions to a device of the advertiser to be displayed at a viewport of the device of the advertiser; and
distributing advertisements to users not included in the remarketing list based on keywords selected, by the advertiser at the device of the advertiser, from the keyword suggestions.

2. The method of claim 1, wherein the first performance measure is a number of impressions.

3. The method of claim 1, wherein the first performance measure is a number of advertisement selections.

4. The method of claim 1, further comprising:
generating campaign data specifying an advertising campaign for the advertiser based at least in part on one or more of the keyword suggestions.

5. The method of claim 4, further comprising:
receiving campaign selection data indicating that the advertiser has activated the advertising campaign.

6. The method of claim 1, wherein the user events further comprise impressions of the advertisements to the users by the user devices.

7. (canceled)

8. The method of claim 1, wherein, for each of the user devices, the user events comprise selections of advertisements presented to a user by the user device during a time period before a time the user device requested the web page of the advertiser and during a time period after the user device requested the web page of the advertiser.

9. The method of claim 1, wherein generating keyword suggestions comprises:
for each of the target keywords, determining a positional order of the target keyword with respect to other target keywords based on a second performance measure of advertisements that the target keyword caused to be presented, wherein the second performance measure is different from the first performance measure; and
generating the keyword suggestions based on the positional orders.

10. The method of claim 9, wherein the second performance measure is an advertisement click through rate.

11. The method of claim 1, further comprising:
receiving, from the advertiser, selections of one or more of the keyword suggestions, each selection specifying a keyword suggestion for targeting advertisements of the advertiser to users that are not identified by user identifiers on the remarketing list.

12. A system comprising:
one or more data processors; and
a data storage apparatus encoded with instructions that when executed by the one or more data processors cause the one or more data processors to perform operations comprising:
accumulating multiple different user identifiers of multiple different users that each have previously visited a same advertiser's website;
generating a remarketing list that lists the user identifiers of the users that have visited the same advertiser's website;
accessing user identifier history data that specifies user events that were performed by the users in the remarketing list, wherein the user events comprise selections of advertisements presented to the users and web pages visited by the users;
identifying keyword data specifying first keywords that contributed to presentation of the advertisements to the users in the remarketing list;
for each of one or more of the first keywords:
determining, by one or more data processors, that a first performance measure of advertisements that were presented to users in the remarketing list based on the first keyword meets a first performance threshold; and
in response to determining that the first performance measure meets the first performance threshold, identifying the first keyword as a target keyword;
identifying, based on the user identifier history data, dwell times for the visits to the web pages by the users in the remarketing list, wherein the dwell time is based on a presentation period for the web pages;
identifying second keywords that describe subject matter of the web pages visited by the users in the remarketing list;
for each of one or more of the second keywords:
determining that the dwell time for the web pages described by the second keyword meets a minimum dwell time; and
in response to determining that the dwell time meets the minimum dwell time, identifying the second keyword as a target keyword;
generating keyword suggestions from the target keywords, the keyword suggestions specifying keywords for use in targeting advertisements of the advertiser to users not included in the remarketing list, wherein the keyword suggestions include at least one of the second keywords that was identified as a target keyword;
providing the keyword suggestions to a device of the advertiser to be displayed at a viewport of the device of the advertiser; and
distributing advertisements to users not included in the remarketing list based on keywords selected, by the advertiser at the device of the advertiser, from the keyword suggestions.

13. (canceled)

14. The system of claim 12, wherein generating keyword suggestions comprises:
for each of the target keywords, determining a positional order of the target keyword with respect to other target keywords based on a second performance measure of advertisements that the target keyword caused to be presented, wherein the second performance measure is different from the first performance measure; and
generating the keyword suggestions based on the positional orders.

15. The system of claim 14, wherein the second performance measure is an advertisement click through rate.

16. The system of claim 12, wherein the first performance measure is a number of impressions.

17. The system of claim 12, wherein the first performance measure is a number of advertisement selections.

18. The system of claim 12, wherein the instructions that when executed by the one or more data processors cause the one or more data processors to perform further operations comprising:
receiving, from the advertiser, selections of one or more of the keyword suggestions, each selection specifying a keyword suggestion for targeting advertisements of the advertiser to users that are not identified by user identifiers on the remarketing list.

19. A computer-readable storage medium having instructions stored thereon, which, when executed by one or more data processors, causes the one or more processor to perform operations comprising:
accumulating multiple different user identifiers of multiple different users that each have previously visited a same advertiser's website;
generating a remarketing list that lists the user identifiers of the users that have visited the same advertiser's website;
accessing user identifier history data that specifies user events that were performed by the users in the remarketing list, wherein the user events comprise selections of advertisements presented to the users and web pages visited by the users;
identifying keyword data specifying first keywords that contributed to presentation of the advertisements to the users in the remarketing list;
for each of one or more of the first keywords:
determining, by one or more data processors, that a first performance measure of advertisements that were presented to users in the remarketing list based on the first keyword meets a first performance threshold; and
in response to determining that the first performance measure meets the first performance threshold, identifying the first keyword as a target keyword;
identifying, based on the user identifier history data, dwell times for the visits to the web pages by the users in the remarketing list, wherein the dwell time is based on a presentation period for the web pages;
identifying second keywords that describe subject matter of the web pages visited by the users in the remarketing list;
for each of one or more of the second keywords:
determining that the dwell time for the web pages described by the second keyword meets a minimum dwell time; and
in response to determining that the dwell time meets the minimum dwell time, identifying the second keyword as a target keyword;
generating keyword suggestions from the target keywords, the keyword suggestions specifying keywords for use in targeting advertisements of the advertiser to users not included in the remarketing list, wherein the keyword suggestions include at least one of the second keywords that was identified as a target keyword;
providing the keyword suggestions to a device of the advertiser to be displayed at a viewport of the device of the advertiser; and
distributing advertisements to users not included in the remarketing list based on keywords selected, by the advertiser at the device of the advertiser, from the keyword suggestions.

20. (canceled)
